(19) United States
(12) Patent Application Publication
(10) Pub. No.: US 2014/0268661 A1
(43) Pub. Date: Sep. 18, 2014

(54) DECORATION WITH WAVING ACCESSORY

(71) Applicant: Chin-Sheng YANG, Tainan City (TW)

(72) Inventor: Chin-Sheng YANG, Tainan City (TW)

(21) Appl. No.: 13/798,155

(22) Filed: Mar. 13, 2013

(51) Int. Cl. F21S 10/00

(52) U.S. Cl. CPC F21S 10/002; F21W 2121/00
USPC 362/101

(57) ABSTRACT

A decoration with a waving accessory includes a fluid-lamp body, a pedestal and an accessory in the fluid-lamp body, wherein the accessory is arranged with connection of a flexible wire. Thereby, when the fluid-lamp body is loaded with a fluid, the accessory can be carried by the fluid so as to suspend. When the fluid-lamp body is waving, the accessory can be caused to suspend and wave so as to create a visual effect.

### BACKGROUND OF THE DISCLOSURE

a) Field of the Disclosure

The invention relates to a decoration with a waving accessory, and more particularly, to a water lamp designed for visual enjoyments in environmental space, wherein visual effects can be produced by means of the fluid in the water lamp causing accessories to suspend and wave.

b) Brief Description of the Related Art

Generally, decorative accessories on the desktop are nothing more than picture frames, toys, etc., all of which are static ornaments with beautiful views. Water lamps with sequins, glitters or decorations internally are designed, wherein manually shaking inversely or electricity may lead sequins, glitters or decorations to move with a fluid so as to produce visual enjoyment. Visual effects vary with different objects in the water lamp, so various water lamps can be developed with a variety of visual changes, versatility or interests. Accordingly, designs for water lamps are expertise for a researcher of environmental decorations.

### SUMMARY OF THE DISCLOSURE

In accordance with the present invention, a decoration with a waving accessory includes a fluid-lamp body having a transparent solid structure configured to contain a fluid therein, a pedestal provided with an opening facing up, wherein the opening is secured to the fluid-lamp body, wherein a light emitter is arranged in the pedestal and under the fluid-lamp body and controlled by a switch set to be turned on or off, and an accessory having a solid structure arranged in the fluid-lamp body, wherein the accessory comprises a fastener, a waving element over the fastener and a flexible wire having two ends fixed with the fastener and waving element respectively.

Thereby, when the fluid-lamp body is loaded with the fluid, the waving element can be carried by the fluid so as to be separate from the fastener. When the fluid-lamp body is waving, the waving element can be caused to suspend and wave so as to create a visual effect.

The accompanying drawings are included to provide a further understanding of the invention, and are incorporated as a part of this specification. The drawings illustrate embodiments of the invention and, together with the description, serve to explain the principles of the invention.

### BRIEF DESCRIPTION OF THE DRAWINGS

The drawings disclose illustrative embodiments of the present disclosure. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same numeral appears in different drawings, it refers to the same or like components or steps.

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure.

FIG. 1 is a schematically perspective exploded view in accordance with the present invention.

FIG. 2 is a cross-sectional plan view in accordance with the present invention.

FIG. 3 is a schematic view showing a switch in accordance with the present invention.

FIG. 4 is a front view in accordance with an embodiment of the present invention.

FIG. 5 is a cross-sectional partial view in accordance with an embodiment of the present invention.

While certain embodiments are depicted in the drawings, one skilled in the art will appreciate that the embodiments depicted are illustrative and that variations of those shown, as well as other embodiments described herein, may be envisioned and practiced within the scope of the present disclosure.

### DETAILED DESCRIPTION OF THE INVENTION

Illustrative embodiments are now described. Other embodiments may be used in addition or instead. Details that may be apparent or unnecessary may be omitted to save space or for a more effective presentation. Conversely, some embodiments may be practiced without all of the details that are disclosed.

FIG. 1 is a schematically perspective exploded view in accordance with the present invention. FIG. 2 is a cross-sectional plan view in accordance with the present invention. Referring to FIGS. 1 and 2, in accordance with the present invention, a decoration with a waving accessory includes: a fluid-lamp body 1 comprising a transparent hollow body 11 and a bottom transparent cover 12, wherein the fluid-lamp body 1 contains a fluid therein, wherein the fluid is added with sequins or glitters, a pedestal 2 provided with an opening 21 facing up, wherein the opening 21 is secured to the fluid-lamp body 1, wherein a light emitter 31 is arranged in the pedestal 2 and under the fluid-lamp body 1 and controlled by a switch set 3 to be turned on or off, and an accessory 4 having a solid structure arranged in the fluid-lamp body 1, wherein the accessory 4 comprises a fastener 41, a waving element 42 over the fastener 41 and a flexible wire 43 having two ends fixed with the fastener 41 and waving element 42 respectively, wherein the flexible wire 43 can be a nylon wire.

Referring to FIG. 3, the switch set 3 including a power portion 32, a micro-switch 33, a central control unit 34 and the light emitter 31 is assembled on the pedestal 2. The power portion 32 having a reduced volume can be mercury cells. The micro-switch 33 can sense slight motion so as to turn on the power portion 32. The central control unit 34 can be designed to intermittently or selectively start. The light emitter 31 can be a light-emitting diode under the fluid-lamp body 1. The switch set 3 can refer to a traditional electronic design and the detailed description related to the switch set 3 is omitted.

When the fluid-lamp body 1 is loaded with the fluid, the waving element 42 can be carried by the fluid so as to be separate from the fastener 41. When the fluid-lamp body 1 is waving, the waving element 42 can be caused to suspend and wave so as to create a visual effect. In this embodiment, the accessory 4 is a snowman, wherein the fastener 41 is a body of the snowman and the waving element 42 is a head of the snowman.

FIG. 4 is a front view in accordance with an embodiment of the present invention. FIG. 5 is a cross-sectional partial view in accordance with an embodiment of the present invention. Referring to FIGS. 4 and 5, the difference from the above structure is that the bottom transparent cover 12 can serve as a fastener 41a of the accessory 4a. The flexible wire 43 has an end fixed with the bottom transparent cover 12. The waving element 42a can be a head of a snowman. The pedestal 2a can be shaped like a body of the snowman. Thereby, other visual experience can be created.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. Furthermore, unless stated otherwise, the numerical ranges provided are intended to be inclusive of the stated lower and upper values. Moreover, unless stated otherwise, all material selections and numerical values are representative of preferred embodiments and other ranges and/or materials may be used.

The scope of protection is limited solely by the claims, and such scope is intended and should be interpreted to be as broad as is consistent with the ordinary meaning of the language that is used in the claims when interpreted in light of this specification and the prosecution history that follows, and to encompass all structural and functional equivalents thereof.

What is claimed is:

1. A decoration with a waving accessory comprising:
a fluid-lamp body having a transparent solid structure configured to contain a fluid therein;
a pedestal provided with an opening facing up, wherein the opening is secured to the fluid-lamp body, wherein a light emitter is arranged in the pedestal and under the fluid-lamp body and controlled by a switch set to be turned on or off; and
an accessory having a solid structure arranged in the fluid-lamp body, wherein the accessory comprises a fastener, a waving element over the fastener and a flexible wire having two ends fixed with the fastener and waving element respectively, whereby when the fluid-lamp body is loaded with the fluid, the waving element is carried by the fluid so as to be separate from the fastener, and when the fluid-lamp body is waving, the waving element is caused to suspend and wave so as to create a visual effect.

2. The decoration of claim 1, wherein the fluid-lamp body comprises a transparent hollow body and a bottom transparent cover.

3. The decoration of claim 1, wherein the switch set comprises a micro-switch configured to turn on a power portion so as to start the light emitter.

4. The decoration of claim 1, wherein the fluid in the fluid-lamp body is added with sequins or glitters.

5. The decoration of claim 1, wherein the fastener of the accessory comprises a bottom transparent cover.
